(19) United States
(12) Patent Application Publication
(10) Pub. No.: US 2024/0061391 A1
(43) Pub. Date: Feb. 22, 2024

(54) SAFETY SYSTEM AND METHOD USING A SAFETY SYSTEM

(71) Applicant: SICK AG, Waldkirch (DE)

(72) Inventors: Markus HAMMES, Waldkirch (DE); Nikolaus MAYER, Waldkirch (DE)

(21) Appl. No.: 18/235,294

(22) Filed: Aug. 17, 2023

(30) Foreign Application Priority Data
Aug. 18, 2022 (DE) 102022120850.8

(51) Int. Cl. G05B 19/048

(52) U.S. Cl. CPC G05B 19/048

(57) ABSTRACT

A method using a safety system having at least one sensor system having at least one sensor in a first housing and at least one programmable controller in a second housing, wherein the sensor system has a first control and evaluation unit, with the first control and evaluation unit being configured to evaluate sensor data from the sensor of the sensor system and to form first result signals, wherein the programmable controller has a second control and evaluation unit, with the sensor system being configured to transfer sensor data to the second control and evaluation unit, with the second control and evaluation unit being configured to evaluate sensor data from the sensor of the sensor system and to form second result signals, and wherein a comparator unit is provided, with the comparator unit

The present invention relates to a safety system in accordance with the preamble of claim 1 and to a method using a safety system in accordance with the preamble of claim 11.

Functional safety designates that part of the safety of a system that depends on the correct function of the safety related system and on other risk reducing measures.

Since safety can also be achieved in that the function in accordance with the intended purpose is set and a safe state is adopted, the safety integrity of the system is also spoken of.

The standard series IEC 61508 “Functional Safety of Electrical/Electronic/Programmable Electronic Safety-related Systems” accordingly requires the use of various methods to cope with errors
avoidance of systematic errors in development, e.g. specification and implementation errors;
monitoring in ongoing operation to recognize random errors; and
safe dealing with recognized errors and transition into a state previously defined as safe.

The following standards count among the most important relating to functional safety:
EN ISO 13849: Safety of machinery—Safety related parts of control systems
EN/IEC 61508: Functional Safety of Electrical/Electronic/Programmable Electronic Safety-related Systems
EN/IEC 62061: Safety of machinery—Functional safety of Electrical/Electronic/Programmable Electronic Safety related Control Systems

Simple safety functions such as protected field functions or safe measured data generation form part of the prior art for optical safety sensors. These simple safety functions have the advantage of simple intergratability and simple integration in embedded systems. In this respect, the safety sensors themselves perform the functions and reduce the information in an integrated data processing chain to mostly binary information. It is subsequently processed by a safety controller and used to safeguard a hazardous machine.

The processing of the sensor data and the generation of a safety decision is typically carried out completely in the sensor so that only a simple switch signal has to be forwarded to the controller.

There is additionally the possibility of combining the switch signals of a plurality of sensors using simple logical operations in a safety controller and to implement new safety functions on a superior system.

The individual steps of generating information usable in safety engineering are implemented either exclusively on the sensor or on the controller in both cases.

Complex fields of application, for example a human-robot collaboration (abbrv. (HRC) or autonomous vehicles, however, require higher quality safety functions and frequently need image data or even better 3D image data as the basis for such functions.

Examples include object localizing with the query as to where the object is in the field of vision, object tracking with the query as to the trajectory along which an object to be detected moves, and object classification with the query as to whether the detected object is a human or not.

This increased complexity of implementing the safety function solely on a sensor is currently not possible since the performance of internal calculations on the real time system is subject to limitation due to waste heat, costs, and construction size. The more complex the safety function is, the more effort has to be put into diagnostic and error coping mechanisms. Classical approaches for coping with errors such as the redundant design or the redundant, diverse design of the function on the sensor can only be implemented with difficulty for very demanding functions for the same reasons.

The implementation of the high quality safety function on a controller of automation technology is admittedly possible with respect to the available processing power and the possibilities for waste heat dissipation, but there are currently no safety controllers that would be able to perform such demanding safety functions.

It is an object of the invention to provide an improved safety system.

The object is satisfied in accordance with claim 1 by a safety system having at least one sensor system in a first housing and at least one programmable controller in a second housing, wherein the sensor system has a first control and evaluation unit, with the first control and evaluation unit being configured to evaluate sensor data from the sensor of the sensor system and to form first result signals, wherein the programmable controller has a second control and evaluation unit, with the sensor system being configured to transfer sensor data to the second control and evaluation unit, with the second control and evaluation unit being configured to evaluate sensor data from the sensor of the sensor system and to form second result signals, and wherein a comparator unit is provided, with the comparator unit being configured to compare the first result signals and the second result signals with one another and generates safe output signals.

The object is further satisfied in accordance with claim 11 by a method using a safety system having at least one sensor system in a first housing and at least one programmable controller in a second housing, wherein the sensor system has a first control and evaluation unit, with sensor data from the sensor of the sensor system being evaluated by the first control and evaluation unit and first result signals being formed, wherein the programmable controller has a second control and evaluation unit, with sensor data transferring sensor data to the second control and evaluation unit, with sensor data from the sensor of the sensor system being evaluated by the second control and evaluation unit and second result signals being formed, and wherein a comparator unit is provided, with the comparator unit comparing the first result signals and the second result signals and generating safe output signals.

The present invention specifies how a redundant, diverse data processing can be implemented by a staggered safety architecture including a downstream programmable controller or a standard controller in an integrated network and so complex safety functions become available with small additional effort.

In accordance with the invention, it is a safety system or a safety architecture that permits the implementation of complex safety functions using sensor systems designed with one channel and a single channel programmable controller with the aid of a redundant diverse architecture in staggered form without having to put in the great additional effort of a multichannel architecture. The invention starts from the idea that it is advantageous for complex safety functions to utilize the principles of redundancy and diversity. The invention provides a solution for how these principles can be used in that the redundancy and diversity are distributed lengthways, that is in series, over the chain of sensor system and programmable controller.

The heart of the invention is the staggered use of diverse redundancy in the safety system having the sensor system and the programmable controller. Staggered here means that both components, that is the sensor system and the programmable controller, perform the safety functions in one channel in each case in this sequential data processing chain and a comparison is made in a downstream processing step whether the results agree within predefined boundaries. Both elements, that is the sensor system and the programmable controller, can thereby be designed as single channel in each case and the effort for doubled hardware or the disadvantages of locally occurring waste heat are avoided.

For this purpose, the sensor system additionally conducts the measured data, that the sensor system itself uses for the performance of the safety function, to the programmable controller.

The sensor system has devices, implementations, and/or measures to avoid common cause failures since the data foundation that the programmable controller uses for the determination of the functional result is not independent of the sensor system.

The results of the redundant diverse functional evaluation are compared in accordance with the principles of functional safety and are correspondingly formed in a safety related output signal or safe output signals.

The diversity of the function performance advantageously not only relates to the component of the performance, that is the sensor system and the programmable controller, but also, for example, to the hardware used, e.g. an embedded sensor system processor or an industrial PC for the programmable controller, the operating system used, and the algorithm of the functions used. An evaluation process or a system of artificial intelligence (AI) or evaluation processes or a system of machine reading can optionally also be used here.

In a further development of the invention, at least one tolerance range is provided in the comparator unit, with the comparator unit being configured to compare the first result signals and the second result signal with one another while taking account of the tolerance range and generating safe output signals.

A tolerant definition can thus be used that considers permitted deviations of the two functional results as agreeing in the total result. The diversity will generally not result in one hundred percent congruent results of the two functional paths.

In a further development of the invention, the programmable controller has the comparator unit.

It is then also possible with this comparator unit to carry out the final comparison operation on the programmable controller itself. This checking of an expectation is a further effective principle of coping with errors.

In a further development of the invention, the sensor system has a test data generator.

In accordance with the further development, the sensor system can additionally or alternatingly feed test data in the form of a measured data set and the associated functional result into the further processing chain by means of the test data generator. Further errors such as the functional performance on the programmable controller or the comparison of the results in operation can thus be avoided or discovered.

In a further development of the invention, the sensor system is a 3D image sensor system.

It is, for example, possible due to the architecture in accordance with the invention to implement complex safety functions such as object localization, object tracking, object classification using a single channel programmable controller and a powerful programmable controller or a programmable standard controller.

The safety function to be carried out implemented by the first control and evaluation unit and the second control and evaluation unit receives the 3D image data (and optionally further sensor data) of the 3D image sensor system as an input and determines the position of relevant objects in these data.

A distinguishing of the foreground and the background pixels can take place on the basis of protected fields or reference zones in a preprocessing step.

Indications on the position and optionally also on the size and the direction of movement are generated for every object determined. It can, for example, take place using a bounding box and a movement vector.

The function is carried out on the 3D image sensor system itself, on the one hand, and on the programmable controller, on the other hand, but on the basis of the same sensor data. The sensor data are provided to the programmable controller via a measured data flow that is secured against transmission errors, for example, by additional measures.

The sensor system additionally takes up measures, for example, to avoid common cause failures. For example, the checking of the flawless function of the measured data acquisition, function checks of the sensor system, checksums/CRCs for internal and external data transmissions, feeding in of test data. Common cause failures can thus be avoided. The performance of the first safety function in the sensor system itself is, however, not checked internally in the sensor system. This validation takes place downstream by the comparison of the equivalent second safety function on the programmable controller and the comparison.

The programmable controller itself uses very few safety measures. The check of co-supplied plausibilization information of the measured data of the sensor system above all takes place in the programmable controller. Since the programmable controller is generally a great deal more powerful than the sensor system itself, more complex algorithms or even neural networks can be used here to evaluate the 3D image data. Provision is, for example, made that a pixel based segmentation of the detected objects is carried out here.

Coping with common cause failures is an important module of the present safety concept. A possible failure of this kind can be the loss or the falsification of sensor data by errors in the sensor system or by influencing by external effects. The transmission of data from the sensor system to the programmable controller is also relevant in this connection.

Measures to cope with or reveal these errors are already integrated in the sensor system for this reason. The 3D image sensor system includes such measures by means of integrated safety functions, for example.

The 3D image sensor system provides the possibility of providing higher quality functions in addition to simple safety functions such as the protected field evaluation. The abundance of data and the quality in principle allows more specific and higher quality information to be extracted from the sensor data. The exact position, the size, and the direction of movement can, for example, be determined from the 3D image data instead of the simple binary information such as that an object is located in the protected zone. This information is very important for autonomous machines and applications such as the collaboration of humans and robots.

The distinguishing of humans and other objects is furthermore very useful for the optimization of productive automation routines.

If, however, machines are to act independently as part of automation processes (machines act independently according to fixed rules) or autonomization processes (machines decide independently in a flexible/complex environment according to fixed objectives), high demands are made on the safety of the routines. All the elements of the machine control from the sensor up to the actuator have to be adapted and operated according to the requirements of functional safety.

In a further development of the invention, the programmable controller has a signal output for requesting test data and the sensor system has a signal input for requesting test data, with the signal output being connected to the signal input.

A mechanism is thus provided by which the programmable controller requests such test data pairs via, for example, a digital input on the sensor system.

Additional errors of the sensor system can then be coped with and the demands on the sensor system itself can be reduced.

In a further development of the invention, the programmable controller is configured to output a plausibility measure based on the comparison of the first result signals and the second result signals of the comparator unit.

The safety system can thus output a plausibility measure in addition to the compared functional result and the decision whether it is usable from a technical safety aspect. This plausibility measure delivers information on the degree of agreement of the two functional results and can enable a more specific further processing.

A generation of a plausibility measure thus takes place in addition to the output decision whether the results agree.

In a further development of the invention, the programmable controller is configured to evaluate stored historical information.

The programmable controller can thus include further information in the calculation of the functional result. Information from past points in time or information from a configuration process can flow in here, for example.

In a further development of the invention, the programmable controller is configured to evaluate a further sensor system, with the further sensor system being configured to transfer sensor data to the second control and evaluation unit, with the second control and evaluation unit being configured to evaluate sensor data from the sensor of the further sensor system and to form third result signals.

Sensor systems can thus also be made use of that do not have any special safety architecture and were not developed according to the rules of functional safety.

The use of AI based functions in the second control and evaluation unit is provided, for example. However, AI based functions can also be provided in the first control and evaluation unit.

In a further development of the invention, the programmable controller has the comparator unit.

An additional safety controller is, for example, provided for the comparison of the two results, with the safety controller having a comparator unit, with the comparator unit comparing the first result signals and the second result signals with one another and generating safe output signals. In this case, the programmable controller has the second control and evaluation unit and the comparator unit is arranged in the safety controller.

One or more 3D image sensor systems can, for example, be provided, a performant programmable controller and optionally an additional safety controller.

Both functional results are, for example, forwarded for comparison to a subsequent safety controller in the form of simple integer position data. The safety controller has all the mechanisms required from a technical safety aspect for this comparison.

A mechanism is thus provided by which the programmable controller or the subsequent safety controller requests such test data pairs via, for example, a digital input on the sensor system. Additional errors of the sensor system can then be coped with and the demands on the sensor system itself can be reduced.

The sensor systems can be formed, for example, by laser scanners, 2D camera systems, light grids, radar sensors, or similar sensor systems.

The programmable controller can, for example, also be formed by a machine controller, for example a robot controller or a vehicle computer.

The invention will also be explained in the following with respect to further advantages and features with reference to the enclosed drawing and embodiments. The Figures of the drawing show in:

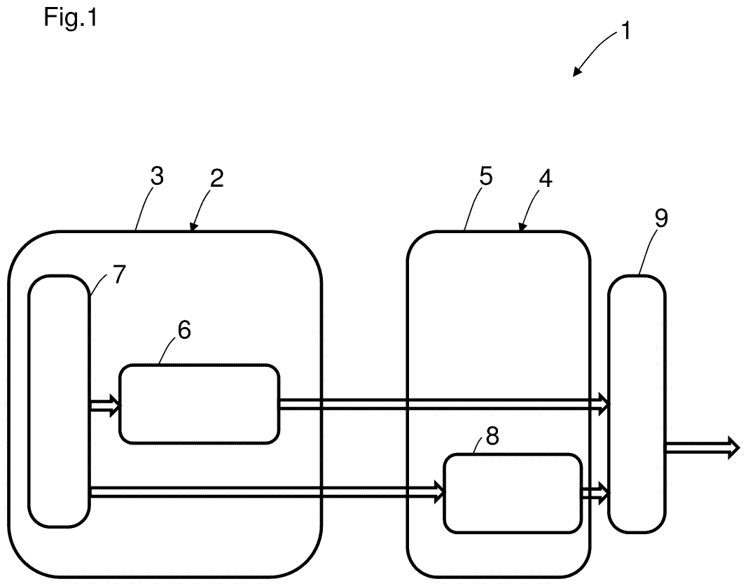

FIG. 1 to FIG. 4 and FIG. 6 respectively a safety system;

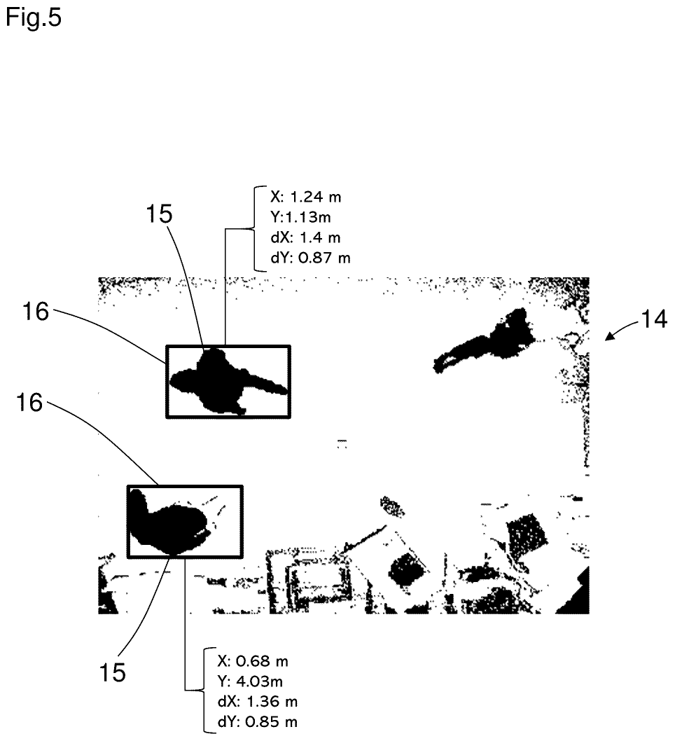

FIG. 5 3D image data

In the following Figures, identical parts are provided with identical reference numerals.

FIG. 1 shows a safety system 1 having at least one sensor system 2 in a first housing 3 and at least one programmable controller 4 in a second housing 5, wherein the sensor system 2 has a first control and evaluation unit 6, with the first control and evaluation unit 6 being configured to evaluate sensor data from the sensor 7 of the sensor system 2 and to form first result signals, wherein the programmable controller 4 has a second control and evaluation unit 8, with the sensor system 2 being configured to transfer sensor data to the second control and evaluation unit 8, with the second control and evaluation unit 8 being configured to evaluate sensor data from the sensor 7 of the sensor system 2 and to form second result signals, and wherein a comparator unit 9 is provided, with the comparator unit 9 being configured to compare the first result signals and the second result signals and generates safe output signals.

In accordance with the invention, it is a safety system 1 or a safety architecture that permits the implementation of complex safety functions having sensor systems 2 designed with one channel and a single channel programmable controller 4 with the aid of a redundant diverse architecture in staggered form without having to put in the great additional effort of a multichannel architecture. The redundancy and diversity are distributed lengthways, that is in series, over the chain of sensor system 2 and programmable controller 4.

The heart is the staggered use of diverse redundancy in the safety system 1 having the sensor system 2 and the programmable controller 4. Staggered here means that both components, that is the sensor system 2 and the programmable controller 4, perform the safety functions in one channel in each case in this sequential data processing chain and a comparison is made in a downstream processing step in the comparator unit 9 whether the results agree within predefined boundaries. Both elements, that is the sensor system 2 and the programmable controller 4, can thereby respectively be designed as single channel.

For this purpose, the sensor system 2 additionally conducts the measured data, that the sensor system 2 itself uses for the performance of the safety function, to the programmable controller 4.

The sensor system 2 has devices, implementations, and/or measures to avoid common cause failures since the data foundation that the programmable controller 4 uses for the determination of the functional result is not independent of the sensor system 2.

The results of the redundant diverse functional evaluation are compared in accordance with the principles of functional safety and a safety related output signal or safe output signals are correspondingly formed.

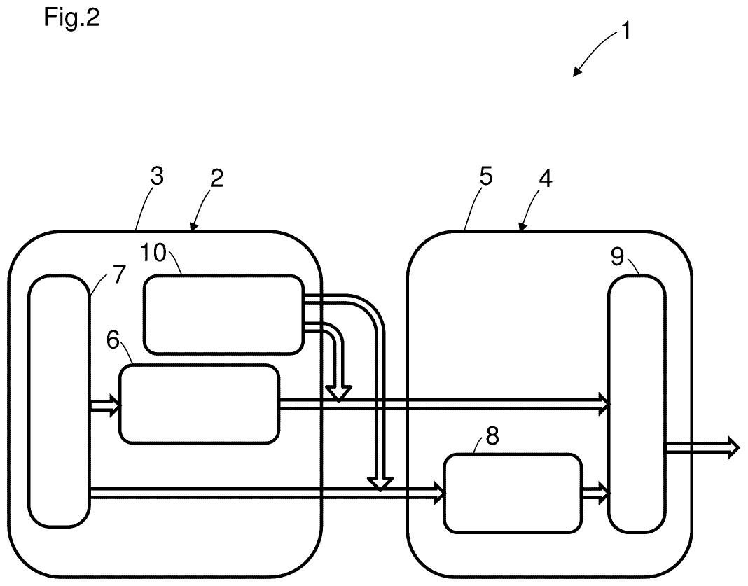

In accordance with FIG. 2, the programmable controller 4 has the comparator unit 9.

It is then also possible with this measure to carry out the final comparison operation of the comparator unit 9 on the programmable controller 4 itself. This checking of an expectation is a further effective principle of coping with errors.

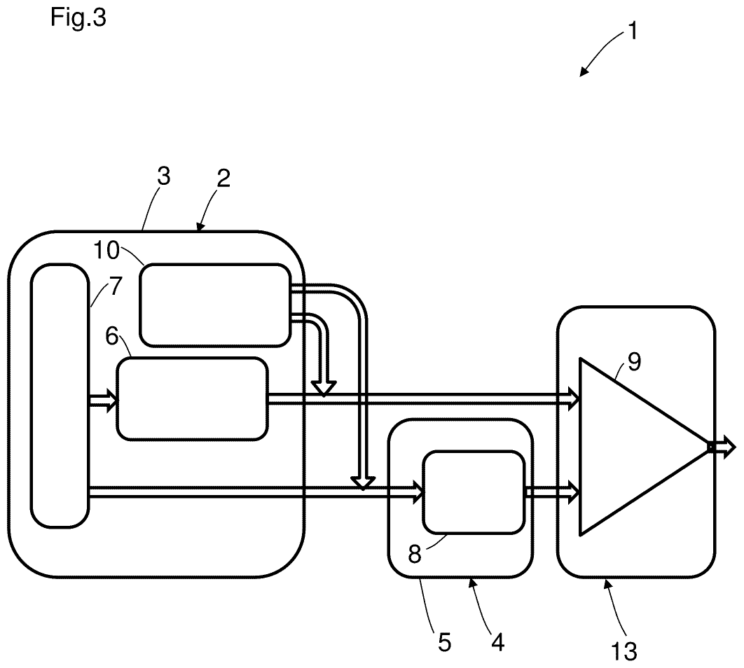

In accordance with FIG. 3, a safety controller 13 has the comparator unit 9.

The additional safety controller 13 is, for example, provided for the comparison of the two results, with the safety controller 13 having the comparator unit 9, with the comparator unit 9 comparing the first result signals and the second result signals with one another and generating safe output signals. In this case, the programmable controller 4 has the second control and evaluation unit 8 and the comparator unit 9 is arranged in the safety controller 13.

In accordance with FIG. 2, the sensor system 2 has a test data generator 10.

The sensor system 2 can thus additionally or alternatingly feed test data in the form of a measured data set and the associated functional result into the further processing chain by means of the test data generator 10. Further errors such as the functional performance on the programmable controller 4 or the comparison of the results in operation can thus be avoided or discovered.

It is then also possible with this measure to carry out the final comparison operation on the programmable controller 4 itself. This checking of an expectation is a further effective principle of coping with errors.

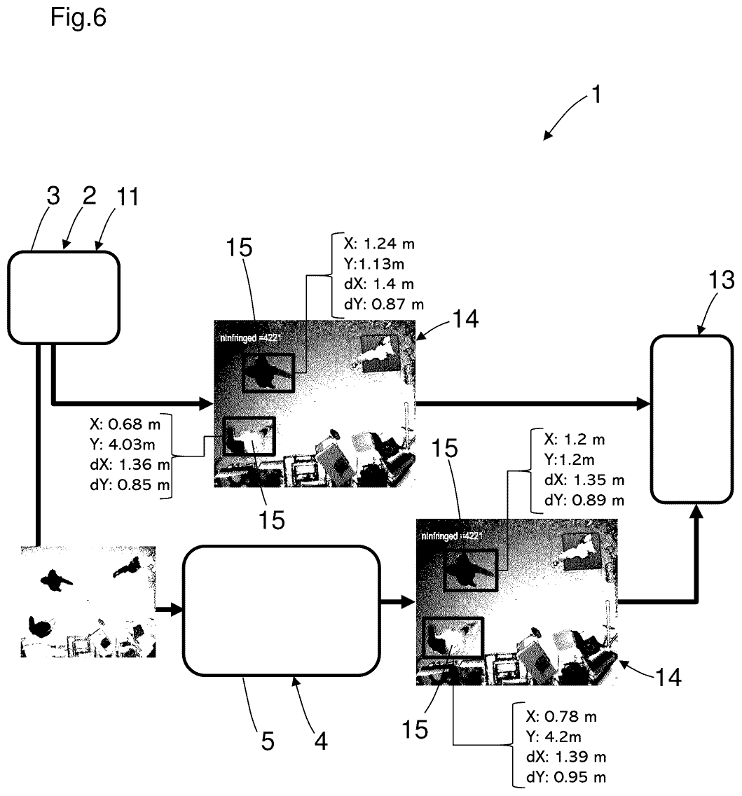

In accordance with FIG. 6, the sensor system 2 is a 3D image sensor system 11.

It is, for example, possible to implement complex safety functions such as object localization, object tracking, object classification using a 3D image sensor system 11 or a 3D camera sensor or a powerful programmable controller 4 or a programmable standard controller 4

The safety function to be carried out implemented by the first control and evaluation unit 6 and the second control and evaluation unit 8 receives the 3D image data 14 of the 3D image sensor system 11 as an input and determines the position of relevant objects 15 in these data.

The image data 14 from FIG. 6 are shown in more detail in FIG. 5. A distinguishing of the foreground and the background pixels can take place on the basis of protected fields or reference zones in a preprocessing step.

Indications on the position and optionally also on the size and the direction of movement are generated for every object 15 determined. This is shown in FIG. 5 and FIG. 6 by the values behind the curly brackets. It can, for example, take place on a bounding box 16 and a movement vector.

The function is carried out on the 3D image sensor system 11 in accordance with FIG. 6 itself, on the one hand, and on the programmable controller 4, on the other hand, but on the basis of the same sensor data. The sensor data are provided to the programmable controller 4 via a measured data flow that is secured against transmission errors, for example, by additional measures.

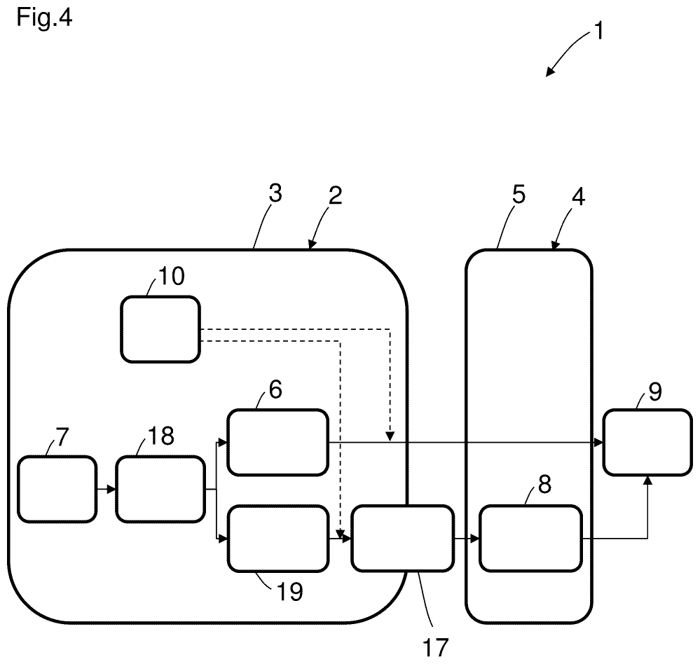

The sensor system 2 in accordance with FIG. 4 additionally takes up measures, for example, to avoid common cause failures. The checking of the flawless function of the measured data acquisition of the sensor 7 and of a preprocessing 18 of the measured data, functional checks of the sensor system 2, checksums/CRCs for internal and external data transmissions 17, feeding in of test data by the test data generator 10, and a provision of the sensor data, for example. Common cause failures can thus be avoided. The performance of the first safety function in the sensor system 2 itself is, however, not checked internally in the sensor system 2. This validation takes place downstream by the comparison of the equivalent second safety function on the programmable controller 4 and the comparison in the comparator unit.

The programmable controller 4 itself uses very few safety measures. The check of co-supplied plausibilization information of the measured data of the sensor system 2 above all takes place in the programmable controller 4.

Since the programmable controller 4 is generally a great deal more powerful than the sensor system 2 itself, more complex algorithms or even neural networks can be used here to evaluate the 3D image data 14. Provision is, for example, made that a pixel based segmentation of the detected objects is carried out here.

Coping with common cause failures is an important module of the present safety concept. A possible failure of this kind can be the loss or the falsification of sensor data by errors in the sensor system 2 or by influencing by external effects. The transmission of data by the data transmission 17 from the sensor system 2 to the programmable controller 4 is also relevant in this connection.

Measures to cope with or reveal these errors are already integrated in the sensor system 2 for this reason. The 3D image sensor system 11 includes such measures by means of integrated safety functions, for example.

The 3D image sensor system 11 provides the possibility of providing higher quality functions in addition to simple safety functions such as the protected field evaluation. The abundance of data and the quality in principle allows more specific and higher quality information to be extracted from the sensor data. The exact position, the size, and the direction of movement can, for example, be 14 determined from the 3D image data 14 instead of the simple binary information such as that an object is located in the protected zone. This information is very important for autonomous machines and applications such as the collaboration of humans and robots.

The distinguishing of humans and other objects is furthermore very useful for the optimization of productive automation routines.

If, however, machines are to act independently as part of automation processes (machines act independently according to fixed rules) or autonomization processes (machines decide independently in a flexible/complex environment according to fixed objectives), high demands are made on the safety of the routines. All the elements of the machine control from the sensor up to the actuator have to be adapted and operated according to the requirements of functional safety.

For example, the programmable controller 4 has a signal output for requesting test data and the sensor system 2 has a signal input for requesting test data, with the signal output being connected to the signal input.

A mechanism is thus provided by which the programmable controller 4 requests such test data pairs via, for example, a digital input on the sensor system. Additional errors of the sensor system 2 can then be coped with and the demands on the sensor system 2 itself can be reduced.

For example, the programmable controller 4 is configured to output a plausibility measure based on the comparison of the first result signals and the second result signals of the comparator unit 9.

The safety system 1 can thus output a plausibility measure in addition to the compared functional result and the decision whether it is usable from a technical safety aspect. This plausibility measure delivers information on the degree of agreement of the two functional results and can enable a more specific further processing.

A generation of a plausibility measure thus takes place in addition to the output decision whether the results agree.

For example, the programmable controller 4 is configured to evaluate stored historical information.

The programmable controller 4 can thus include further information in the calculation of the functional result. Information from past points in time or information from a configuration process can flow in here, for example.

For example, the programmable controller 4 is configured to evaluate a further sensor system, with the further sensor system being configured to transfer sensor data to the second control and evaluation unit 8, with the second control and evaluation unit 8 being configured to evaluate sensor data from the sensor of the further sensor system and to form third result signals.

Sensor systems can thus also be made use of that do not have any special safety architecture and were not developed according to the rules of functional safety.

One or more 3D image sensor systems 11 can, for example, be provided, a performant programmable controller 4 and optionally an additional safety controller 13.

Both functional results are, for example, forwarded for comparison to a subsequent safety controller 13 in the form of simple integer position data. The safety controller 13 has the comparator unit and all the mechanisms required from a technical safety aspect for this comparison.

A mechanism is thus provided by which the programmable controller 4 or the subsequent safety controller 13 requests such test data pairs via, for example, a digital input on the sensor system 2. Additional errors of the sensor system 2 can then be coped with and the demands on the sensor system 2 itself can be reduced.

The sensor systems 2 can be formed, for example, by laser scanners, 2D camera systems, light grids, radar sensors, or similar sensor systems.

The programmable controller 4 can, for example, also be formed by a machine controller, for example a robot controller or a vehicle computer.

### REFERENCE NUMERALS

1 safety system
2 sensor system
3 first housing
4 programmable controller
5 second housing
6 control and evaluation unit
7 sensor
8 second control and evaluation unit
9 comparator unit
10 test data generator
11 3D image sensor system
12 sensor system
13 safety controller
14 3D image data
15 objects
16 bounding box
17 data transmission
18 preprocessing
19 providing sensor data

1. A safety system having at least one sensor system having at least one sensor in a first housing and at least one programmable controller in a second housing, wherein the sensor system has a first control and evaluation unit, with the first control and evaluation unit being configured to evaluate sensor data from the sensor of the sensor system and to form first result signals, wherein the programmable controller has a second control and evaluation unit,
wherein the sensor system is configured to transfer sensor data to the second control and evaluation unit,
with the second control and evaluation unit being configured to evaluate sensor data from the sensor of the sensor system and to form second result signals,
and with a comparator unit being provided, with the comparator unit being configured to compare the first result signals and the second result signals with one another and generates safe output signals.

2. The safety system in accordance with claim 1, wherein at least one tolerance range is provided in the comparator unit, with the comparator unit being configured to compare the first result signals and the second result signal with one another while taking account of the tolerance range and generating safe output signals.

3. The safety system in accordance with claim 1, wherein the programmable controller has the comparator unit.

4. The safety system in accordance with claim 1, wherein the sensor system has a test data generator.

5. The safety system in accordance with claim 1, wherein the sensor system is a 3D image sensor system.

6. The safety system in accordance with claim 1, wherein the programmable controller has a signal output for requesting test data and the sensor system has a signal input for requesting test data, with the signal output being connected to the signal input.

7. The safety system in accordance with claim 1, wherein the programmable controller is configured to output a plausibility measure based on the comparison of the first result signals and the second result signals of the comparator unit.

8. The safety system in accordance with claim 1, wherein the programmable controller is configured to evaluate stored historical information.

9. The safety system in accordance with claim 1, wherein the programmable controller is configured to evaluate a further sensor system, with the further sensor system being configured to transmit sensor data to the second control and evaluation unit,
with the second control and evaluation unit being configured to evaluate sensor data from the sensor of the further sensor system and to form third result signals.

10. The safety system in accordance with claim 1, wherein a safety controller has the comparator unit.

11. A method using a safety system having at least one sensor system having at least one sensor in a first housing and at least one programmable controller in a second housing, wherein the sensor system has a first control and evaluation unit, with sensor data from the sensor of the sensor system being evaluated by the first control and evaluation unit and first result signals being formed, wherein the programmable controller has a second control and evaluation unit,
wherein the sensor system transmits sensor data to the second control and evaluation unit,
with sensor data from the sensor of the sensor system being evaluated by the second control and evaluation unit and second result signals being formed;
and with a comparator unit being provided, with the comparator unit comparing the first result signals and the second result signals with one another and generating safe output signals.
